(19) United States
(12) Patent Application Publication
(10) Pub. No.: US 2023/0030053 A1
(43) Pub. Date: Feb. 2, 2023

(54) INFORMATION PROCESSING DEVICE, COMMUNICATION SYSTEM, AND GENERATION METHOD

(71) Applicant: Mitsubishi Electric Corporation, Tokyo (JP)

(72) Inventor: Tatsuhiko ITOHARA, Tokyo (JP)

(73) Assignee: Mitsubishi Electric Corporation, Tokyo (JP)

(21) Appl. No.: 17/790,559

(22) PCT Filed: Feb. 12, 2020
(86) PCT No.: PCT/JP2020/005244

§ 371 Date: Jul. 1, 2022

(51) Int. Cl. G06N 20/00

(52) U.S. Cl. CPC G06N 20/00

(57) ABSTRACT

An information processing device includes an acquisition unit that acquires attribute information regarding a first user, acquires information indicating a user having attribute information similar to the attribute information regarding the first user, and acquires first acquisition information as at least one item of information out of appliance condition information as information regarding condition of an appliance used by the user and sensor information as information obtained by detecting the user by a sensor and a first generation unit that generates a first learning model, which identifies behavior of the first user, based on the first acquisition information.

### TECHNICAL FIELD

The present disclosure relates to an information processing device, a communication system, a generation method and a generation program.

### BACKGROUND ART

There has been known a system that provides a resident with a service such as power consumption management of the resident's house, watching over a resident or in-advance control of a household electrical appliance. In this system, behavior recognition technology is used. When the accuracy of the behavior recognition is high, the system is capable of providing a service that suits the resident's needs. In this regard, there has been proposed a technology of estimating a user's intention (see Patent Reference 1), for example. Further, in this regard, there has been proposed a technology regarding learning (see Patent Reference 2).

### PRIOR ART REFERENCE

### Patent Reference

Patent Reference 1: Japanese Patent Application Publication No. 2007-109110

Patent Reference 2: WO 2018/051841

### SUMMARY OF THE INVENTION

### Problem to be Solved by the Invention

Incidentally, there are cases where it is desired to identify behavior by using a learning model. For example, there are cases where it is desired to identify behavior of a resident by using a learning model. Thus, it is necessary to first generate the learning model. When generating the learning model, there are cases where big data as learning data is used. However, the big data includes a great amount of unnecessary information. Thus, a learning model generated by using the big data is incapable of identifying the behavior with high accuracy.

An object of the present disclosure is to generate a learning model identifying the behavior with high accuracy.

### Means for Solving the Problem

An information processing device according to an aspect of the present disclosure is provided. The information processing device includes an acquisition unit that acquires attribute information regarding a first user, acquires information indicating a user having attribute information similar to the attribute information regarding the first user, and acquires first acquisition information as at least one item of information out of appliance condition information as information regarding condition of an appliance used by the user and sensor information as information obtained by detecting the user by a sensor and a first generation unit that generates a first learning model, which identifies behavior of the first user, based on the first acquisition information.

### Effect of the Invention

According to the present disclosure, a learning model identifying the behavior with high accuracy can be generated.

### BRIE DESCRIPTION OF THE DRAWINGS

FIG. 1 is a diagram showing an example of a communication system in a first embodiment.

FIG. 2 is a diagram showing the configuration of hardware included in a server in the first embodiment.

FIG. 3 is a diagram showing an example of household electrical appliances and the like existing in a house in the first embodiment.

FIG. 4 is a diagram showing functional blocks included in the server in the first embodiment.

FIG. 5 is a diagram showing an example of an appliance condition information table in the first embodiment.

FIG. 6 is a diagram showing an example of a sensor information table in the first embodiment.

FIG. 7 is a diagram showing an example of an attribute information table in the first embodiment.

FIG. 8 is a diagram showing functional blocks included in a server in a second embodiment.

FIG. 9 is a diagram showing an example of household electrical appliances and the like existing in a house in a third embodiment.

FIG. 10 is a diagram showing functional blocks included in a server in the third embodiment.

FIG. 11 is a diagram showing functional blocks included in a server in a fourth embodiment.

FIG. 12 is a diagram showing functional blocks included in a server in a fifth embodiment.

### MODE FOR CARRYING OUT THE INVENTION

Embodiments will be described below with reference to the drawings. The following embodiments are just examples and a variety of modifications are possible within the scope of the present disclosure.

### First Embodiment

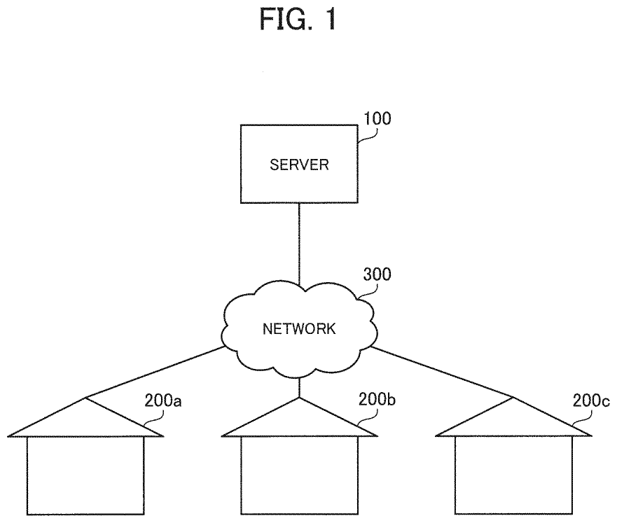

FIG. 1 is a diagram showing an example of a communication system in a first embodiment. FIG. 1 shows a server 100 and houses 200a, 200b and 200c. The communication system includes the server 100 and communication devices existing in the houses 200a, 200b and 200c. The server 100 communicates with the communication devices existing in the houses 200a, 200b and 200c via a network 300.

The server 100 is referred to also as an information processing device or a cloud server. The server 100 is a device that executes a generation method. The communication devices existing in the houses 200a, 200b and 200c are routers which will be described later, for example.

FIG. 1 shows three houses as an example. The number of houses is not limited to three. Further, each house can also be an apartment, a condominium or the like.

Next, hardware included in the server 100 will be described below.

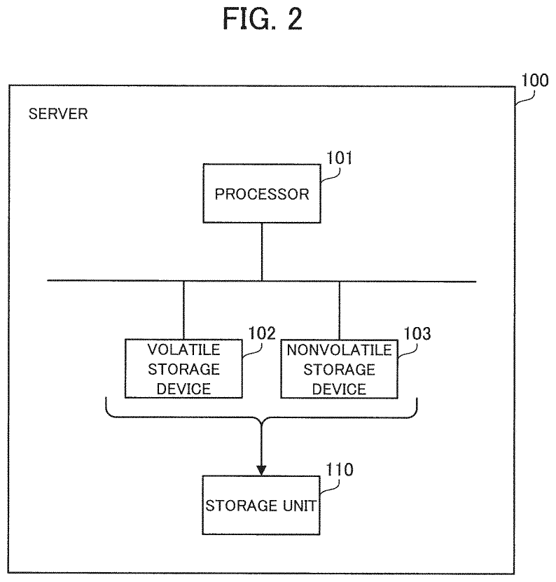

FIG. 2 is a diagram showing the configuration of the hardware included in the server in the first embodiment. The server 100 includes a processor 101, a volatile storage device 102 and a nonvolatile storage device 103.

The processor 101 controls the whole of the server 100. For example, the processor 101 is a Central Processing Unit (CPU), a Field Programmable Gate Array (FPGA) or the like. The processor 101 can also be a multiprocessor. The server 100 may also be implemented by a processing circuitry or implemented by software, firmware or a combination of software and firmware. Incidentally, the processing circuitry may be either a single circuit or a combined circuit.

The volatile storage device 102 is main storage of the server 100. The volatile storage device 102 is a Random Access Memory (RAM), for example. The nonvolatile storage device 103 is auxiliary storage of the server 100. The nonvolatile storage device 103 is a Hard Disk Drive (HDD) or a Solid State Drive (SSD), for example.

Here, a storage unit 110 is implemented as a storage area reserved in the volatile storage device 102 or the nonvolatile storage device 103.

Next, household electrical appliances and the like existing in a house will be described below. In the following description, the houses 200a, 200b and 200c will be collectively referred to as houses 200.

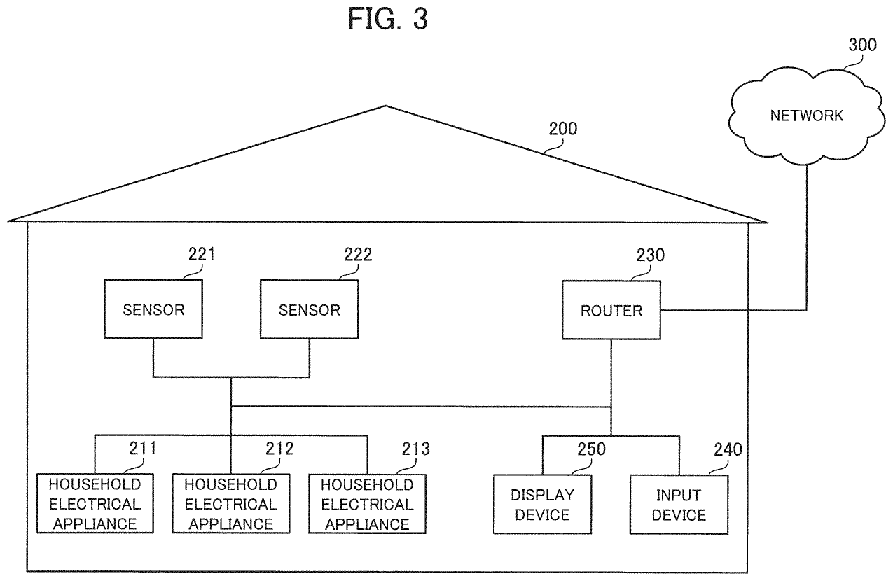

FIG. 3 is a diagram showing an example of the household electrical appliances and the like existing in the house in the first embodiment. In the house 200, there exist household electrical appliances 211, 212 and 213, sensors 221 and 222, a router 230, an input device 240 and a display device 250.

The household electrical appliances 211, 212 and 213, the sensors 221 and 222, the input device 240 and the display device 250 communicate with the router 230. For example, the communication is wire communication or wireless communication. The wireless communication is implemented by using Wireless Fidelity (Wi-Fi) (registered trademark), Bluetooth (registered trademark) or Wireless Smart Utility Network (Wi-SUN) (registered trademark), for example.

The household electrical appliances 211, 212 and 213, the sensors 221 and 222, the input device 240 and the display device 250 communicate with the server 100 via the router 230.

The household electrical appliances 211, 212 and 213 are devices used by a resident. The household electrical appliances 211, 212 and 213 transmit appliance condition information to the server 100 via the router 230. The appliance condition information is information regarding condition of the appliance. For example, the appliance condition information indicates power on, power off, a mode of use, or the like. When the appliance condition information is transmitted, a household identifier (ID), a user ID and time information are added to the appliance condition information.

The household ID may be referred to also as a residence ID. For example, the household ID is assigned to each house. For example, a household ID “A1” is assigned to the house 200a. A household ID “B1” is assigned to the house 200b. A household ID “C1” is assigned to the house 200c.

The user ID is information for identifying a user. For example, a user ID “All” is assigned to a certain user residing in the house 200a. The time information indicates the time when the household electrical appliance was operated, for example.

As above, each household electrical appliance 211, 212, 213 transmits the appliance condition information with the household ID, the user ID and the time information added thereto to the server 100. For example, the household electrical appliance 211 that is used exclusively by the user ID “All” transmits the appliance condition information with the household ID “A1”, the user ID “All” and the time information added thereto to the server 100.

The sensor 221, 222 are a temperature sensor, a humidity sensor, a human detection sensor or a door sensor, for example. The sensor 221, 222 transmit sensor information to the server 100 via the router 230. The sensor information is information acquired from the sensor. For example, the sensor information is a temperature of a user or an ambient temperature around a user. When the sensor information is transmitted, the household ID, the user ID and the time information are added to the sensor information. The household ID and the user ID have the same meanings as described earlier. The time information indicates the time when the sensor 221, 222 performed measurement or detection, for example.

As above, each sensor 221, 222 transmits the sensor information with the household ID, the user ID and the time information added thereto to the server 100.

The router 230 is a relaying device. The router 230 can also be a Home Energy Management System (HEMS) controller.

The input device 240 is a device used by a user as a resident. For example, the input device 240 is a HEMS controller, a smartphone or a Personal Computer (PC).

Each user inputs information regarding attributes of the user to the input device 240. The information regarding attributes will hereinafter be referred to as attribute information. The attribute information may also be regarded as information regarding the user or personal information. For example, the attribute information indicates age, occupational category, life style, and so forth. The attribute information may include the number of residents. Further, the attribute information may include size of a room, a direction, and installation positions of household electrical appliances and sensors.

The input device 240 transmits the attribute information with the household ID and the user ID added thereto to the server 100 via the router 230.

The display device 250 is a HEMS controller, a smartphone, a PC or a television set, for example. The display device 250 displays information transmitted from the server 100. For example, the display device 250 displays behavior of a user identified by the server 100 and a result of executing a service as will be described later.

Next, functions of the server 100 will be described below.

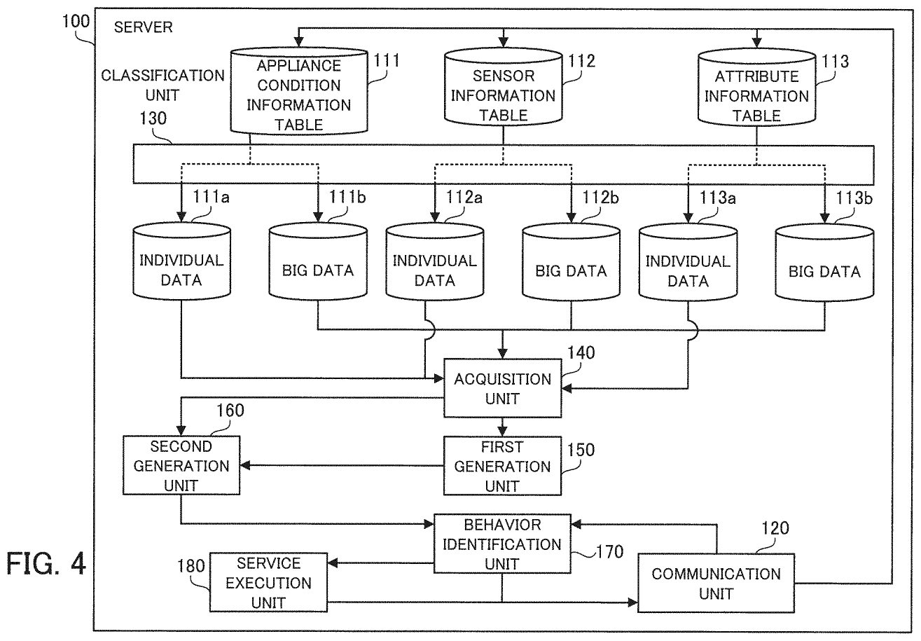

FIG. 4 is a diagram showing functional blocks included in the server in the first embodiment. The server 100 includes a communication unit 120, a classification unit 130, an acquisition unit 140, a first generation unit 150, a second generation unit 160, a behavior identification unit 170 and a service execution unit 180. Incidentally, the acquisition unit 140, the first generation unit 150 and the second generation unit 160 may be referred to also as a model learning unit.

Part or all of the communication unit 120, the classification unit 130, the acquisition unit 140, the first generation unit 150, the second generation unit 160, the behavior identification unit 170 and the service execution unit 180 may be implemented by the processor 101. Part or all of the communication unit 120, the classification unit 130, the acquisition unit 140, the first generation unit 150, the second generation unit 160, the behavior identification unit 170 and the service execution unit 180 may be implemented as modules of a program executed by the processor 101. For example, the program executed by the processor 101 is referred to also as a generation program. The generation program has been recorded in a record medium, for example.

The storage unit 110 stores an appliance condition information table 111, a sensor information table 112 and an attribute information table 113. The appliance condition information table 111, the sensor information table 112 and the attribute information table 113 will be described later.

Further, the storage unit. 110 stores individual data 111a, big data 111b, individual data 112a, big data 112b, individual data 113a and big data 113b. The individual data 111a, the big data 111b, the individual data 112a, the big data 112b, the individual data 113a and the big data 113b will be described later.

The communication unit 120 communicates with the router 230 via the network 300. The communication unit 120 receives the appliance condition information with the household ID, the user ID and the time information added thereto from the router 230.

The communication unit 120 registers the appliance condition information with the household ID, the user ID and the time information added thereto in the appliance condition information table 111. Here, the appliance condition information table 111 will be described below.

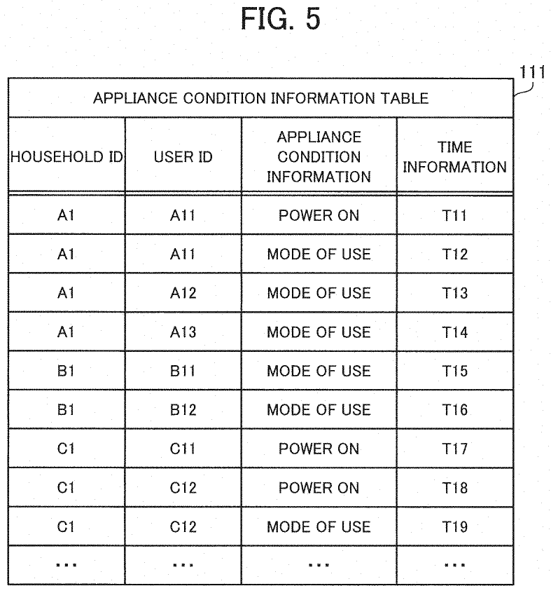

FIG. 5 is a diagram showing an example of the appliance condition information table in the first embodiment. The appliance condition information table 111 is stored in the storage unit 110. Information received by the communication unit 120 from the router 230 is registered in the appliance condition information table 111.

Further, the communication unit 120 receives the sensor information with the household ID, the user ID and the time information added thereto from the router 230. The communication unit 120 registers the sensor information with the household ID, the user ID and the time information added thereto in the sensor information table 112. Here, the sensor information table 112 will be described below.

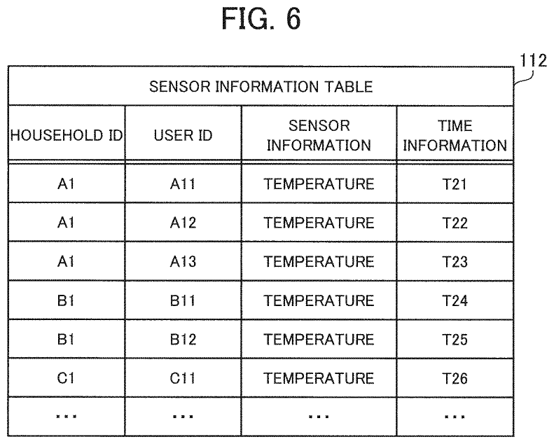

FIG. 6 is a diagram showing an example of the sensor information table in the first embodiment. The sensor information table 112 is stored in the storage unit 110. Information received by the communication unit 120 from the router 230 is registered in the sensor information table 112.

Furthermore, the communication unit 120 receives the attribute information with the household ID and the user ID added thereto from the router 230. The communication unit 120 registers the attribute information with the household ID and the user ID added thereto in the attribute information table 113. Here, the attribute information table 113 will be described below.

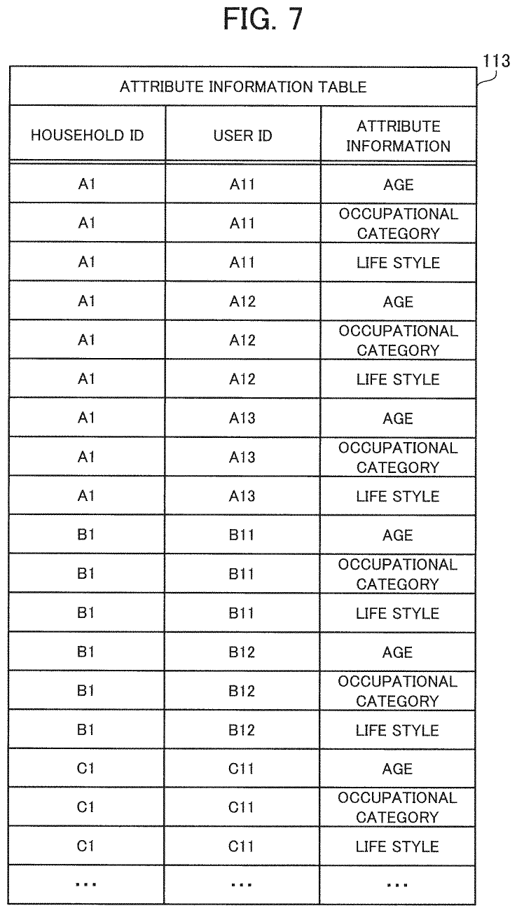

FIG. 7 is a diagram showing an example of the attribute information table in the first embodiment. The attribute information table 113 is stored in the storage unit 110. Information received by the communication unit 120 from the router 230 is registered in the attribute information table 113.

As above, the information transmitted from the router installed in each house 200a, 200b, 200c is registered in the appliance condition information table 111, the sensor information table 112 and the attribute information table 113.

The communication unit 120 transmits the appliance condition information with the household ID, the user ID and the time information added thereto to the behavior identification unit 170. Further, the communication unit 120 transmits the sensor information with the household ID, the user ID and the time information added thereto to the behavior identification unit 170.

The classification unit 130 classifies the information registered in each table into information regarding a user as a target and information other than the aforementioned information. Specifically, from the appliance condition information table 111, the classification unit 130 classifies information regarding the user ID of the target user as the individual data 111a. From the appliance condition information table 111, the classification unit 130 classifies information other than the information regarding the user ID as the big data 111b. From the sensor information table 112, the classification unit 130 classifies information regarding the user ID of the target user as the individual data 112a. From the sensor information table 112, the classification unit 130 classifies information other than the information regarding the user ID as the big data 112b. From the attribute information table 113, the classification unit 130 classifies information regarding the user ID of the target user as the individual data 113a. From the attribute information table 113, the classification unit 130 classifies information other than the information regarding the user ID as the big data 113b.

Incidentally, the target user may be selected based on information received from the router 230. The target user may also be a user designated by an external device connectable to the server 100. Illustration of the external device in the drawing is left out. The target user may also be randomly selected by the server 100.

The acquisition unit 140 acquires the attribute information regarding the target user. The acquisition unit 140 acquires information indicating a user having attribute information similar to the attribute information regarding the target user. In other words, the acquisition unit 140 acquires information indicating one or more users corresponding to attribute information similar to the attribute information regarding the target user. The process will be described concretely below. Incidentally, the user ID of the target user is referred to simply as a target user ID. Further, the target user is referred to also as a first user.

The acquisition unit 140 acquires attribute information regarding the target user ID from the individual data 113a. The acquisition unit 140 acquires a user ID in attribute information similar to the attribute information regarding the target user ID from the big data 113b. For example, the acquisition unit 140 acquires a user ID “C11” in attribute information similar to the attribute information regarding the target user TD “All” from the big data 113b. The acquisition unit 140 may also acquire a plurality of user IDs from the big data 113b.

Next, examples of the method of the acquisition will be described below. For example, the acquisition unit 140 selects one user ID from user IDs included in the big data 113b. The acquisition unit 140 converts the attribute information regarding the target user ID and the attribute information regarding the selected user ID to vectors and calculates a Euclidean distance by use of base vectors obtained based on the vectors as the result of the conversion and principal component analysis. When the Euclidean distance is less than or equal to a predetermined threshold value, the acquisition unit 140 judges that the attribute information regarding the selected user ID is similar to the attribute information regarding the target user ID.

Alternatively, for example, the acquisition unit 140 calculates a Mahalanobis distance based on base vector directions obtained by principal component analysis. The acquisition unit 140 acquires a user ID in attribute information similar to the attribute information regarding the target user ID from the big data 113b based on the Mahalanobis distance.

Alternatively, for example, the acquisition unit 140 calculates a similarity level between the attribute information regarding the target user ID and each piece of attribute information included in the big data 113b and acquires a user ID resulting in a similarity level less than or equal to a predetermined threshold value from the big data 113b.

As above, the acquisition unit 140 acquires a user ID in attribute information similar to the attribute information regarding the target user ID from the big data 113b.

Incidentally, the above description was given of the case where the acquisition unit 140 acquires the target user ID from the individual data 113a and acquires a user ID in attribute information similar to the attribute information regarding the target user ID from the big data 113b. Namely, the above description was given of the case where the acquisition unit 140 acquires these items of information from the storage unit 110. It is also possible for the acquisition unit 140 to acquire these items of information from an external device connectable to the server 100.

The acquisition unit 140 acquires at least one of appliance condition information as information regarding the condition of an appliance used by a user having attribute information similar to the attribute information regarding the target user ID and sensor information as information obtained by detecting the user by a sensor. The acquired information is referred to also as first acquisition information. Here, this appliance condition information may also be represented as information regarding the condition of an appliance relevant to the user. Further, this sensor information may also be represented as information acquired from a sensor relevant to the user. Incidentally, the appliance and the sensor relevant to the user are an appliance and a sensor existing in the user's room, for example. In the following description, it is assumed that the acquisition unit 140 acquires the appliance condition information and the sensor information. The process will be described in detail below. The acquisition unit 140 acquires appliance condition information corresponding to a user ID in attribute information similar to the attribute information regarding the target user ID from the big data 111b. The acquisition unit 140 acquires sensor information corresponding to a user ID in attribute information similar to the attribute information regarding the target user ID from the big data 112b.

By this process, the acquisition unit 140 is capable of acquiring the appliance condition information and the sensor information corresponding to the user ID in the attribute information similar to the attribute information regarding the target user ID from the storage unit 110. It is also possible for the acquisition unit 140 to acquire the appliance condition information and the sensor information corresponding to the user ID in the attribute information similar to the attribute information regarding the target user ID from the external device.

The first generation unit 150 generates a learning model based on the appliance condition information and the sensor information corresponding to the user ID in the attribute information similar to the attribute information regarding the target user ID. In other words, the first generation unit 150 generates the learning model by executing a learning process by use of the appliance condition information and the sensor information as learning data. For example, the first generation unit 150 generates the learning model by using an algorithm such as Hidden Marcov Model (HMM), Convolution Neural Network (CNN) or Long Short-Time Memory (LSTM). It is also possible for the first generation unit 150 to generate the learning model by combining the above-described algorithms, or generate the learning model by using an algorithm other than the above-described algorithms. Further, a behavior label is associated with the behavior identified by the learning model. For example, the behavior label indicates sleep, meal, cleaning, bathing, cooking, television watching, or the like. The behavior label may lack some of the aforementioned examples or may be a combination of some of the aforementioned examples.

Here, the learning model generated by the first generation unit 150 is a learning model that identifies the behavior of the target user. In other words, the learning model generated by the first generation unit 150 is a learning model that estimates the behavior of the target user. The learning model generated by the first generation unit 150 is referred to as a first learning model. The learning model generated by the first generation unit 150 may also be referred to as a reasoning model or a first learned model.

The acquisition unit 140 acquires at least one of information regarding the condition of an appliance used by the target user and information obtained by detecting the target user by a sensor. Namely, the acquisition unit 140 acquires at least one of the individual data 11a and the individual data 112a from the storage unit 110. It is also possible for the acquisition unit 140 to acquire at least one of the individual data 111a and the individual data 112a from an external device. The acquired information is referred to also as second acquisition information. In the following description, it is assumed that the acquisition unit 140 acquires the individual data 111a and the individual data 112a from the storage unit 110. Here, the individual data 11a is referred to also as user appliance condition information. The individual data 111a may also be represented as information regarding the condition of an appliance relevant to the target user. Further, the individual data 112a is referred to also as user sensor information. The individual data 112a may also be represented as information acquired from a sensor relevant to the target user. Incidentally, the appliance and the sensor relevant to the target user are an appliance and a sensor existing in the target user's room, for example.

The second generation unit 160 generates a learning model by using the individual data 111a, the individual data 112a and the first learning model. In other words, the second generation unit 160 generates the learning model by executing a learning process by use of the individual data 111a and the individual data 112a as learning data. Namely, the second generation unit 160 performs additional learning for the first learning model.

The learning model generated by the second generation unit 160 is a learning model identifying the behavior of the target user. The learning model generated by the second generation unit 160 is referred to as a second learning model. Further, the learning model generated by the second generation unit 160 may also be referred to as a reasoning model or a second learned model.

Incidentally, the algorithm for generating the second learning model is the algorithm described earlier, for example. Further, for example, the second generation unit 160 may also generate the second learning model by not changing a part of the first learning model and performing an additional learning on the remaining part of the first learning model based on the individual data 111a and the individual data 112a like fine tuning. The second generation unit 160 may also generate the second learning model by a method other than the above-described methods.

The first leaning model and the second leaning model may be updated at a time designated by a user or updated at a time determined by the system. Further, the frequency of the update can be every day, every week, every month, or the like.

The behavior identification unit 170 identifies the behavior of the user having the user ID added to the appliance condition information and the sensor information transmitted from the communication unit 120 based on the appliance condition information, the sensor information and the second learning model. The behavior identification unit 170 transmits information indicating the identified behavior of the user to the communication unit 120 and the service execution unit 180.

The service execution unit 180 executes a service based on the information indicating the identified behavior of the user. The service executed by the service execution unit 180 is an elderly watching over service, for example. For example, when the information indicating the identified behavior of the user indicates that the user is lying down for a certain time at a place other than an electrically heated rug in a living room, the service execution unit 180 transmits an alert to a relative. Further, the service executed by the service execution unit 180 is an in-advance control service, for example. For example, when the information indicating the identified behavior of the user indicates that the user is taking a preparatory action before taking a bath in the winter season, the service execution unit 180 executes control of turning on heating appliances installed in a dressing room and a bathroom.

Incidentally, there are cases where the service execution unit 180 executing a service transmits a service execution command to the router 230 via the communication unit 120. For example, when turning on the heating appliances installed in the dressing room and the bathroom, the service execution unit 180 transmits a command indicating the turning on of the heating appliances installed in the dressing room and the bathroom to the router 230. Accordingly, the heating appliances installed in the dressing room and the bathroom are turned on.

The service execution unit 180 transmits an execution result of the service to the communication unit 120. The communication unit 120 transmits the information indicating the identified behavior of the user and the service execution result to the router 230. The router 230 transmits the information indicating the identified behavior of the user and the service execution result to the display device 250. Accordingly, a user can view the display device 250 and thereby recognize the behavior of the user and the service execution result.

According to the first embodiment, the server 100 generates the first learning model based on the appliance condition information and the sensor information corresponding to the user ID in the attribute information similar to the attribute information regarding the target user ID. When generating the first learning model, the server 100 does not generate the first learning model by using all the data included in the big data 111b and 112b. Namely, when generating the first learning model, the server 100 generates the first learning model based on information relevant to the target user. Thus, the first learning model is capable of identifying the behavior of the target user with high accuracy. Accordingly, the server 100 is capable of generating a learning model that identifies the behavior with high accuracy.

Further, the server 100 generates the second learning model based on the individual data 111a, the individual data 112a and the first learning model. The individual data 11a includes the appliance condition information corresponding to the target user ID. The individual data 112a includes the sensor information corresponding to the target user ID. The server 100 is capable of generating the second learning model, which identifies the behavior of the user with higher accuracy, by performing the additional learning on the first learning model by using the individual data 111a and the individual data 112a.

### Second Embodiment

Next, a second embodiment will be described below. In the second embodiment, the description will be given mainly of features different from those in the first embodiment. In the second embodiment, the description is omitted for features in common with the first embodiment. FIGS. 1 to 7 are referred to in the description of the second embodiment.

In the first embodiment, the description was given of the case where the target is one user. In the second embodiment, the description will be given of a case where the target is one household.

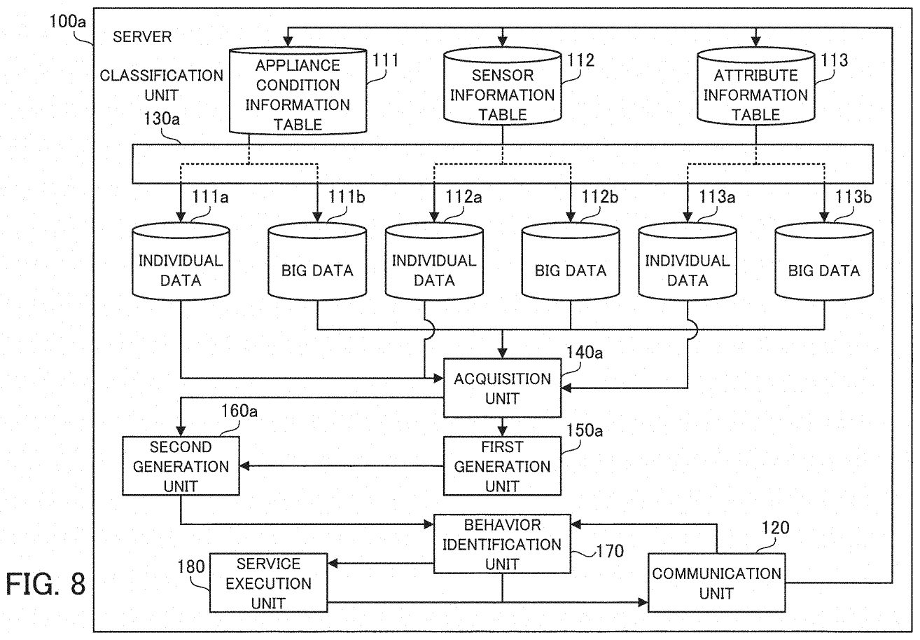

FIG. 8 is a diagram showing functional blocks included in a server in the second embodiment. Each component in FIG. 8 that is the same as a component shown in FIG. 4 is assigned the same reference character as in FIG. 4.

The server 100a includes a classification unit 130a, an acquisition unit 140a, a first generation unit 150a and a second generation unit 160a.

The classification unit 130a classifies the information registered in each table into information regarding a household as a target and information other than the aforementioned information. Specifically, from the appliance condition information table 111, the classification unit. 130a classifies information regarding the household ID of the target household as the individual data 111a. From the appliance condition information table 111, the classification unit 130a classifies information other than the information regarding the household ID of the target household as the big data 111b. From the sensor information table 112, the classification unit 130a classifies information regarding the household ID of the target household as the individual data 112a. From the sensor information table 112, the classification unit 130a classifies information other than the information regarding the household ID of the target household as the big data 112b. From the attribute information table 113, the classification unit 130a classifies information regarding the household ID of the target household as the individual data 113a. From the appliance condition information table 113, the classification unit 130a classifies information other than the information regarding the household ID of the target household as the big data 113b.

Incidentally, the target household may be selected based on information received from the router 230. The target household may also be a household designated by an external device connectable to the server 100a. The target household may also be randomly selected by the server 100a.

Here, in the following description, the household ID of the target household is referred to simply as a target household ID. Incidentally, the target household is referred to also as a first household.

The acquisition unit 140a acquires attribute information regarding a plurality of users belonging to the target household. The plurality of users are all users belonging to the target household, for example. The acquisition unit 140a acquires information indicating a household to which residents having attribute information similar to the attribute information regarding the plurality of users belong. The process will be described in detail below. The acquisition unit 140a acquires the attribute information regarding the target household ID from the individual data 113a. The acquisition unit 140a acquires a household ID in attribute information similar to the attribute information regarding the target household ID from the big data 113b. For example, the acquisition unit 140a acquires a household ID “C1” in attribute information similar to the attribute information regarding the target household ID “A1” from the big data 113b. The acquisition unit 140a may also acquire a plurality of household IDs from the big data 113b.

Incidentally, the method of acquiring the household ID in attribute information similar to the attribute information regarding the target household ID is the same as the method described in the first embodiment, for example. For example, the acquisition unit 140a acquires the household ID in attribute information similar to the attribute information regarding the target household ID by the method using the Euclidean distance, the method using the Mahalanobis distance or the method using the similarity level.

The acquisition unit 140a acquires at least one of appliance condition information as information regarding the condition of an appliance used in the household having the similar attribute information and sensor information as information acquired from a sensor used in the household. The acquired information is referred to also as first household acquisition information. In the following description, it is assumed that the acquisition unit 140a acquires the appliance condition information and the sensor information. Incidentally, the appliance condition information is referred to also as household appliance condition information. The sensor information is referred to also as household sensor information. The process will be described in detail below. The acquisition unit 140a acquires appliance condition information corresponding to a household ID in attribute information similar to the attribute information regarding the target household ID from the big data 111b. The acquisition unit 140a acquires sensor information corresponding to the household ID in the attribute information similar to the attribute information regarding the target household ID from the big data 112b.

By this process, the acquisition unit 140a is capable of acquiring the appliance condition information and the sensor information corresponding to the household ID in the attribute information similar to the attribute information regarding the target household ID.

Incidentally, the above description was given of the case where the acquisition unit 140a acquires a variety of information from the storage unit 110. Similarly to the first embodiment, the acquisition unit 140a may acquire a variety of information from an external device.

The first generation unit 150a generates a learning model based on the appliance condition information and the sensor information corresponding to the household ID in the attribute information similar to the attribute information regarding the target household ID. In other words, the first generation unit 150a generates the learning model by executing a learning process by use of the appliance condition information and the sensor information as learning data. The algorithm for generating the learning model is the same as that in the first embodiment.

The generated learning model is a learning model that identifies the behavior of at least one user among the plurality of users belonging to the target household. The generated learning model is referred to as a first behavior identification learning model. The generated learning model may also be referred to as a reasoning model or a first behavior identification learned model.

The acquisition unit 140a acquires at least one of information regarding the condition of an appliance used in the target household and information acquired from a sensor used in the target household. Namely, the acquisition unit 140a acquires at least one of the individual data 11a and the individual data 112a from the storage unit 110. It is also possible for the acquisition unit 140 to acquire at least one of the individual data 111a and the individual data 112a from an external device. The acquired information is referred to also as second household acquisition information. In the following description, it is assumed that the acquisition unit 140 acquires the individual data 111a and the individual data 112a from the storage unit 110. Here, the individual data 111a is referred to also as user household appliance condition information. The individual data 112a is referred to also as user household sensor information.

The second generation unit 160a generates a learning model based on the individual data 11a, the individual data 112a and the first behavior identification learning model. In other words, the second generation unit 160a generates the learning model by executing a learning process by use of the individual data 111a and the individual data 112a as learning data. Namely, the second generation unit 160a performs additional learning for the first behavior identification learning model. The algorithm for generating the learning model is the same as that in the first embodiment.

The generated learning model is a learning model that identifies the behavior of at least one user among the plurality of users belonging to the target household. The generated learning model is referred to as a second behavior identification learning model. The generated learning model may also be referred to as a reasoning model or a second behavior identification learned model.

According to the second embodiment, the server 100a generates the first behavior identification learning model based on the appliance condition information and the sensor information corresponding to the household ID in the attribute information similar to the attribute information regarding the target household ID. When generating the first behavior identification learning model, the server 100a generates the first behavior identification learning model based on information relevant to the target household. Thus, the first behavior identification learning model is capable of identifying the behavior of a user belonging to the target household with high accuracy. Accordingly, the server 100a is capable of generating a learning model that identifies the behavior with high accuracy.

Further, the server 100a is capable of generating the second behavior identification learning model, which identifies the behavior of the user with higher accuracy, by performing the additional learning on the first behavior identification learning model.

### Third Embodiment

Next, a third embodiment will be described below. In the third embodiment, the description will be given mainly of features different from those in the first and second embodiment. In the third embodiment, the description is omitted for features in common with the first and second embodiment. FIGS. 1 to 8 are referred to in the description of the third embodiment.

In the first and second embodiments, the description was given of cases where the server 100, 100a includes the behavior identification unit 170 and the service execution unit 180. In the third embodiment, a description will be given of a case where an information processing device including a behavior identification unit and a service execution unit exists in the house 200.

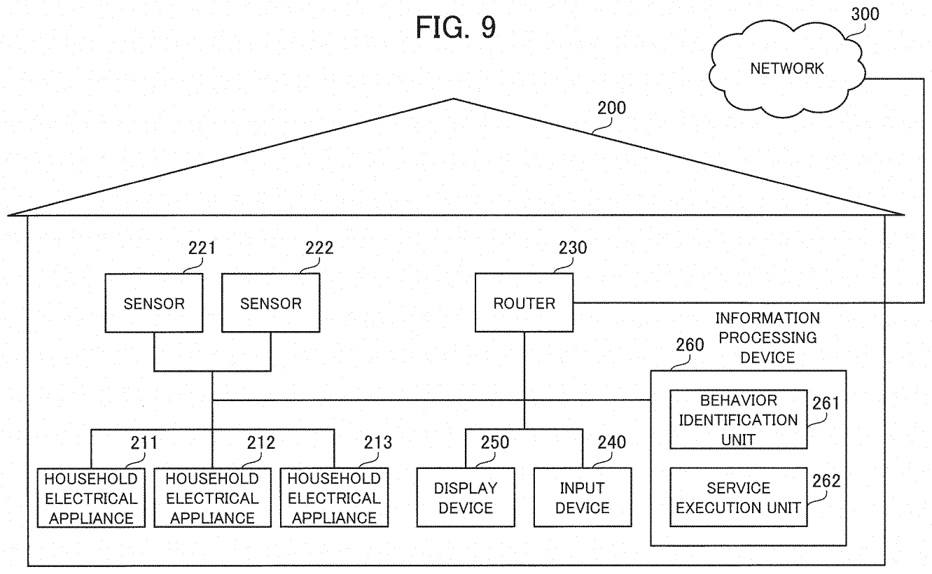

FIG. 9 is a diagram showing an example of household electrical appliances and the like existing in the house in the third embodiment. Each component in FIG. 9 that is the same as a component shown in FIG. 3 is assigned the same reference character as in FIG. 3. The house 200 further includes an information processing device 260.

The information processing device 260 is referred to also as a second information processing device. Here, a server 100b which will be described later is referred to also as a first information processing device. A system including the server 100b and the information processing device 260 is referred to also as a communication system. For example, the information processing device 260 communicates with the server 100b via the router 230.

For example, the information processing device 260 is a HEMS controller, a smartphone or a PC. The information processing device 260 includes a behavior identification unit 261 and a service execution unit 262.

The information processing device 260 acquires the first learning model or the second learning model from the server 100b. Alternatively, the information processing device 260 may acquire the first behavior identification learning model or the second behavior identification learning model from the server 100b.

The behavior identification unit 261 identifies the behavior of a user based on the first learning model or the second learning model and at least one of information regarding the condition of an appliance used by the user and information obtained by detecting the user by a sensor. In other words, the behavior identification unit 261 identifies the behavior of the user based on the first learning model or the second learning model and at least one of information regarding the condition of an appliance relevant to the user and information acquired from a sensor relevant to the user. Specifically, the behavior identification unit 261 identifies the behavior of the user based on the first learning model or the second learning model and at least one of the appliance condition information transmitted from a household electrical appliance and the sensor information transmitted from a sensor. It is also possible for the behavior identification unit 261 to identify the behavior of the user based on the first behavior identification learning model or the second behavior identification learning model and at least one of the appliance condition information transmitted from a household electrical appliance and the sensor information transmitted from a sensor.

The service execution unit 262 executes a service based on the identified behavior of the user. For example, the service execution unit 262 executes one of the services described as examples in the first embodiment.

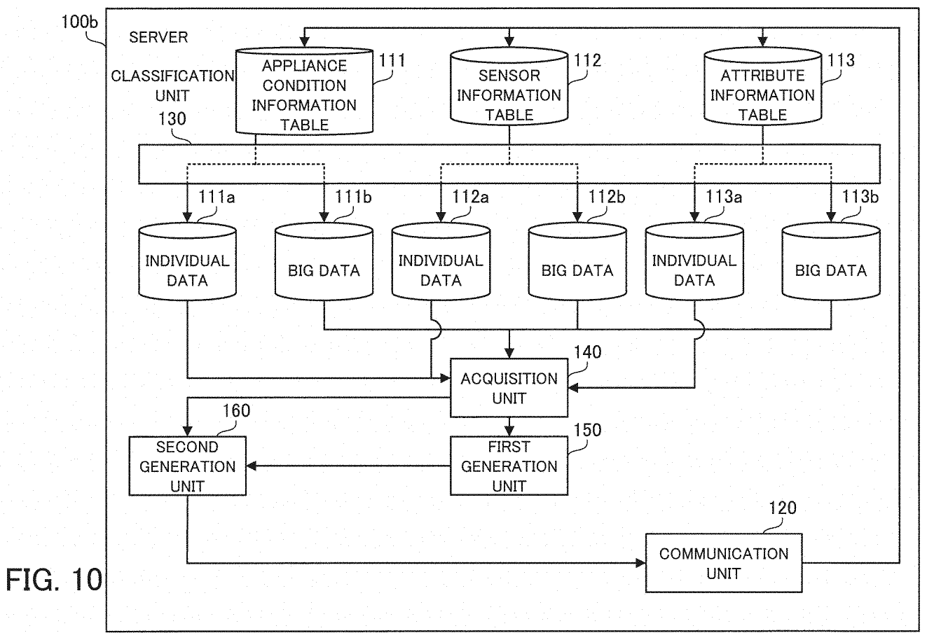

FIG. 10 is a diagram showing functional blocks included in the server in the third embodiment. The server 100b communicates with the information processing device 260 via the router 230. The server 100b does not include the behavior identification unit and the service execution unit. The server 100b may also be configured to include the classification unit 130a, the acquisition unit 140a, the first generation unit 150a and the second generation unit 160a.

The communication unit 120 transmits the first learning model or the second learning model to the information processing device 260 via the router 230. Alternatively, the communication unit 120 may transmit the first behavior identification learning model or the second behavior identification learning model to the information processing device 260 via the router 230.

Here, if the server 100b executes the behavior identification process and the server 100b executes a service, there is a possibility that the server 100b is incapable of quickly executing the service corresponding to the behavior of the user. Namely, there is a possibility that the server 100b is incapable of quickly executing the service corresponding to the behavior of the user since the server 100b and the house 200 are far from each other. In contrast, in the case where the information processing device 260 executes the behavior identification process and the information processing device 260 executes a service, the information processing device 260 is capable of quickly executing the service corresponding to the behavior of the user.

### Fourth Embodiment

Next, a fourth embodiment will be described below. In the fourth embodiment, the description will be given mainly of features different from those in the first embodiment. In the fourth embodiment, the description is omitted for features in common with the first embodiment. FIGS. 1 to 7 are referred to in the description of the fourth embodiment.

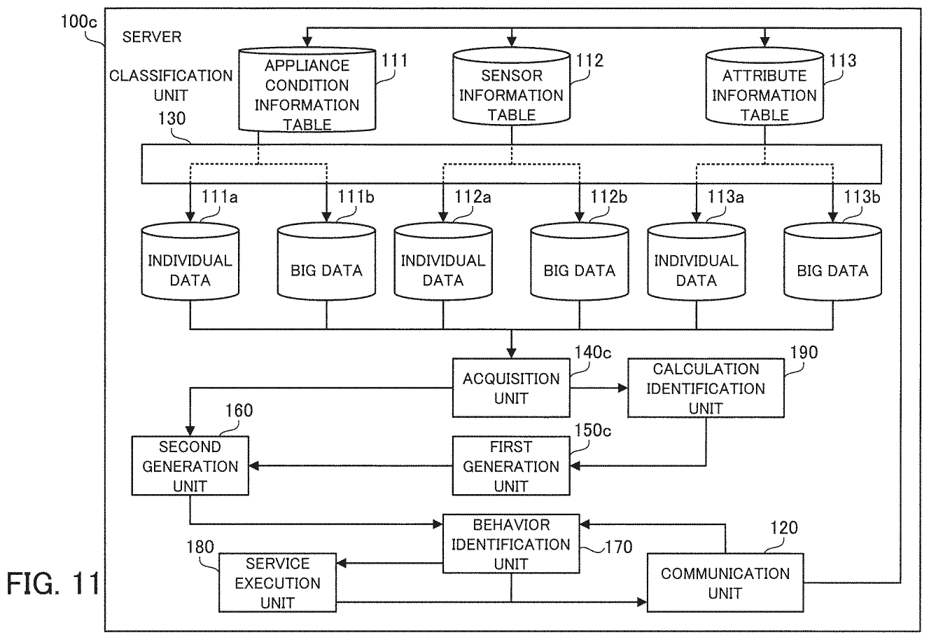

FIG. 11 is a diagram showing functional blocks included in a server in the fourth embodiment. Each component in FIG. 11 that is the same as a component shown in FIG. 4 is assigned the same reference character as in FIG. 4.

The server 100c includes an acquisition unit 140c, a first generation unit 150c and a calculation identification unit 190.

The acquisition unit 140c acquires information indicating a plurality of users having attribute information similar to the attribute information regarding the target user. Specifically, the acquisition unit 140c acquires a plurality of user IDs corresponding to attribute information similar to the attribute information regarding the target user ID from the big data 113b.

The acquisition unit 140c acquires a plurality of pieces of appliance condition information as information regarding the condition of appliances respectively used by the plurality of users. In other words, the acquisition unit 140c acquires a plurality of pieces of appliance condition information as information regarding the condition of a plurality of appliances used by the plurality of users. Further, the plurality of pieces of appliance condition information may also be represented as information regarding the condition of a plurality of appliances relevant to the plurality of users. Incidentally, the plurality of appliances relevant to the plurality of users include one or more appliances existing in the room of each of the plurality of users, for example. The process will be described in detail below. The acquisition unit 140c acquires the appliance condition information corresponding to each of the plurality of user IDs from the big data 1l1b. In other words, the acquisition unit 140c acquires a plurality of pieces of appliance condition information corresponding to the plurality of user IDs from the big data 111b.

The acquisition unit 140c acquires a plurality of pieces of sensor information as information obtained by respectively detecting the plurality of users by a plurality of sensors. The plurality of pieces of sensor information may also be represented as information acquired from a plurality of sensors relevant to the plurality of users. Incidentally, the plurality of sensors relevant to the plurality of users include one or more sensors existing in the room of each of the plurality of users, for example. The process will be described in detail below. The acquisition unit 140c acquires the sensor information corresponding to each of the plurality of user IDs from the big data 112b. In other words, the acquisition unit 140c acquires a plurality of pieces of sensor information corresponding to the plurality of user IDs from the big data 112b.

The acquisition unit 140c acquires the individual data 111a and the individual data 112a. The calculation identification unit 190 calculates information regarding behavior time of the user corresponding to the target user ID based on the individual data 111a and the individual data 112a. Incidentally, the information regarding the behavior time is information that is difficult for a resident to input correctly by using the input device 240. For example, the information regarding the behavior time is wake-up time, bedtime, meal time, presence in a room or the like. Further, the calculation identification unit 190 may calculate information regarding an event that changes depending on the behavior of the user based on the individual data 111a and the individual data 112a.

The calculation identification unit 190 calculates information regarding the behavior time of each of the plurality of users corresponding to the plurality of user IDs based on a plurality of pieces of appliance condition information corresponding to the plurality of user IDs and a plurality of pieces of sensor information corresponding to the plurality of user IDs.

From the information regarding the behavior time of each of the plurality of users corresponding to the plurality of user IDs, the calculation identification unit 190 identifies information regarding the behavior Lime similar to the information regarding the behavior time of the user corresponding to the target user ID. For example, the calculation identification unit 190 identifies the information regarding the behavior time similar to the information regarding the behavior time of the user corresponding to the target user ID by the method using the Euclidean distance, the method using the Mahalanobis distance or the method using the similarity level described in the first embodiment.

The first generation unit 150c generates the first learning model based on the identified information regarding the behavior time, the plurality of pieces of appliance condition information and the plurality of pieces of sensor information. In other words, the first generation unit 150c generates the first learning model by executing a learning process by use of the identified information regarding the behavior time, the plurality of pieces of appliance condition information and the plurality of pieces of sensor information as learning data.

According to the fourth embodiment, the server 100c generates the first learning model by further adding the information regarding the behavior time similar to the information regarding the behavior time of the target user. Accordingly, the server 100c is capable of generating a learning model that identifies the behavior of the target user with higher accuracy.

### Fifth Embodiment

Next, a fifth embodiment will be described below. In the fifth embodiment, the description will be given mainly of features different from those in the second embodiment. In the fifth embodiment, the description is omitted for features in common with the second embodiment. FIGS. 1 to 8 are referred to in the description of the second embodiment.

In the fourth embodiment, the description was given of the case where the target is one user. In the fifth embodiment, the description will be given of a case where the target is one household.

In the fourth embodiment, the description was given of the case where the target is one user. In the fifth embodiment, the description will be given of a case where the target is one household.

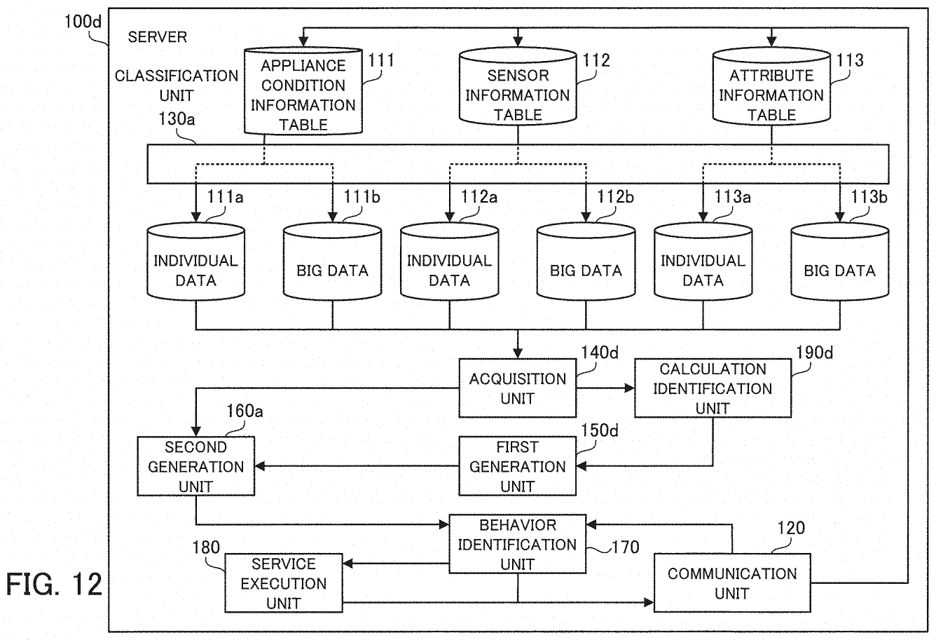

FIG. 12 is a diagram showing functional blocks included in a server in the fifth embodiment. Each component in FIG. 12 that is the same as a component shown in FIG. 8 is assigned the same reference character as in FIG. 8.

The server 100d includes an acquisition unit 140d, a first generation unit 150d and a calculation identification unit 190d.

The acquisition unit 140d acquires information indicating a plurality of households corresponding to a plurality of residents having attribute information similar to the attribute information regarding a plurality of users belonging to the target household. Specifically, the acquisition unit 140d acquires a plurality of household IDs corresponding to attribute information similar to the attribute information regarding the target household ID from the big data 113b.

The acquisition unit 140d acquires a plurality of pieces of appliance condition information as information regarding the condition of an appliance used in each of the plurality of households. In other words, the acquisition unit 140d acquires a plurality of pieces of appliance condition information as information regarding the condition of a plurality of appliances used in the plurality of households. Specifically, the acquisition unit 140d acquires the appliance condition information corresponding to each of the plurality of household IDs from the big data 111b. In other words, the acquisition unit 140d acquires a plurality of pieces of appliance condition information corresponding to the plurality of household IDs from the big data 111b. Incidentally, the plurality of pieces of appliance condition information is referred to also as a plurality of pieces of household appliance condition information.

The acquisition unit 140d acquires a plurality of pieces of household sensor information as information acquired from a sensor used in each of the plurality of households. In other words, the acquisition unit 140d acquires a plurality of pieces of household sensor information as information acquired from a plurality of sensors used in the plurality of households. Specifically, in other words, the acquisition unit 140d acquires the sensor information corresponding to each of the plurality of household IDs from the big data 112b. In other words, the acquisition unit 140d acquires a plurality of pieces of sensor information corresponding to the plurality of household IDs from the big data 112b. Incidentally, the plurality of pieces of sensor information is referred to also as a plurality of pieces of household sensor information.

The acquisition unit 140d acquires the individual data 111a and the individual data 112a. The calculation identification unit 190d calculates information regarding the behavior time of a plurality of users belonging to the household corresponding to the target household ID based on the individual data 111a and the individual data 112a. Further, the calculation identification unit 190d may calculate information regarding an event that changes depending on the behavior of a user based on the individual data 111a and the individual data 112a.

The calculation identification unit 190d calculates information regarding the behavior time of each of the plurality of residents based on the plurality of pieces of appliance condition information corresponding to the plurality of household IDs and the plurality of pieces of sensor information corresponding to the plurality of household IDs.

From the information regarding the behavior time of each of the plurality of residents, the calculation identification unit 190d identifies information regarding the behavior time similar to the information regarding the behavior time of a plurality of users belonging to the household corresponding to the target household ID. For example, the calculation identification unit 190d identifies the information regarding the behavior time similar to the information regarding the behavior time of a plurality of users belonging to the household corresponding to the target household ID by the method using the Euclidean distance, the method using the Mahalanobis distance or the method using the similarity level described in the first embodiment.

The first generation unit 150d generates a learning model based on the identified information regarding the behavior time, the plurality of pieces of appliance condition information and the plurality of pieces of sensor information. In other words, the first generation unit 150d generates the learning model by executing a learning process by use of the identified information regarding the behavior time, the plurality of pieces of appliance condition information and the plurality of pieces of sensor information as learning data. This learning model is the first behavior identification learning model.

According to the fifth embodiment, the server 100d generates the first behavior identification learning model by further adding the information regarding the behavior time similar to the information regarding the behavior time of the users belonging to the target household. Accordingly, the server 100d is capable of generating a learning model that identifies the behavior of a user belonging to the target household with higher accuracy.

Features in the embodiments described above can be appropriately combined with each other.

### DESCRIPTION OF REFERENCE CHARACTERS

100, 100a, 100b, 100c, 100d: server, 101: processor, 102: volatile storage device, 103: nonvolatile storage device, 110: storage unit, 111: appliance condition information table, 111a: individual data, 111b: big data, 112: sensor information table, 112a: individual data, 112b: big data, 113: attribute information table, 113a: individual data, 113b: big data, 120: communication unit, 130, 130a: classification unit, 140, 140a, 140c, 140d: acquisition unit, 150, 150a, 150c, 150d: first generation unit, 160, 160a: second generation unit, 170: behavior identification unit, 180: service execution unit, 190, 190d: calculation identification unit, 200, 200a, 200b, 200c: house, 211, 212, 213: household electrical appliance, 221, 222: sensor, 230: router, 240: input device, 250: display device, 260: information processing device, 261: behavior identification unit, 262: service execution unit, 300: network.

1. An information processing device comprising:
an acquiring circuitry to acquire attribute information regarding a first user, acquires information indicating a user having attribute information similar to the attribute information regarding the first user, and acquire appliance condition information as information regarding condition of an appliance used by the user; and
a first generating circuitry to generate a first learning model, which identifies behavior of the first user, based on the appliance condition information.

2. The information processing device according to claim 1, further comprising a second generating circuitry, wherein
the acquiring circuitry acquires second acquisition information as at least one item of information out of user appliance condition information as information regarding condition of an appliance used by the first user and user sensor information as information obtained by detecting the first user by a sensor, and
the second generating circuitry generates a second learning model, which identifies the behavior of the first user, by using the second acquisition information and the first learning model.

3. An information processing device comprising:
an acquiring circuitry to acquire attribute information regarding a first user, acquires information indicating a plurality of users having attribute information similar to the attribute information regarding the first user, acquire a plurality of pieces of appliance condition information as information regarding condition of appliances respectively used by the plurality of users and a plurality of pieces of sensor information as information obtained by respectively detecting the plurality of users by respectively a plurality of sensors, and acquire user appliance condition information as information regarding condition of an appliance used by the first user and user sensor information as information obtained by detecting the first user by a sensor;
a calculation identifying circuitry to calculate information regarding a behavior time of the first user based on the user appliance condition information and the user sensor information, calculate information regarding the behavior time of each of the plurality of users based on the plurality of pieces of appliance condition information and the plurality of pieces of sensor information, and identify information regarding the behavior time similar to the information regarding the behavior time of the first user out of the information regarding the behavior time of each of the plurality of users; and
a first generating circuitry to generate a first learning model, which identifies behavior of the first user, based on the identified information regarding the behavior time, the plurality of pieces of appliance condition information and the plurality of pieces of sensor information.

4. The information processing device according to claim 3, further comprising a second generating circuitry to generate a second learning model, which identifies the behavior of the first user, by using the user appliance condition information, the user sensor information and the first learning model.

5. An information processing device comprising:
an acquiring circuitry to acquire attribute information regarding a plurality of users belonging to a first household, acquire information indicating a household to which residents having attribute information similar to the attribute information regarding the plurality of users belong, and acquire first household acquisition information as at least one item of information out of household appliance condition information as information regarding condition of an appliance used in the household and household sensor information as information acquired from a sensor used in the household; and
a first generating circuitry to generate a first behavior identification learning model, which identifies behavior of at least one user among the plurality of users, based on the first household acquisition information.

6. The information processing device according to claim 5, further comprising a second generating circuitry wherein
the acquiring circuitry acquires second household acquisition information as at least one item of information out of user household appliance condition information as information regarding condition of an appliance used in the first household and user household sensor information as information acquired from a sensor used in the first household, and
the second generating circuitry generates a second behavior identification learning model, which identifies the behavior of at least one user among the plurality of users, by using the second household acquisition information and the first behavior identification learning model.

7. The information processing device according to claim 5, further comprising a calculation identifying circuitry, wherein
the acquiring circuitry acquires information indicating a plurality of households corresponding to a plurality of residents having attribute information similar to the attribute information regarding the plurality of users, acquires a plurality of pieces of household appliance condition information as information regarding condition of an appliance used in each of the plurality of households and a plurality of pieces of household sensor information as information acquired from a sensor used in each of the plurality of households, and acquires user household appliance condition information as information regarding condition of an appliance used in the first household and user household sensor information as information acquired from a sensor used in the first household,
the calculation identifying circuitry calculates information regarding a behavior time of the plurality of users based on the user household appliance condition information and the user household sensor information, calculates information regarding the behavior time of each of the plurality of residents based on the plurality of pieces of household appliance condition information and the plurality of pieces of household sensor information, and identifies information regarding the behavior time similar to the information regarding the behavior time of the plurality of users in the information regarding the behavior time of each of the plurality of residents, and
the first generating circuitry generates the first behavior identification learning model based on the identified information regarding the behavior time, the plurality of pieces of household appliance condition information and the plurality of pieces of household sensor information.

8. The information processing device according to claim 7, further comprising a second generating circuitry to generate a second behavior identification learning model, which identifies the behavior of at least one user among the plurality of users, by using the user household appliance condition information, the user household sensor information and the first behavior identification learning model.

9. A communication system comprising:
a first information processing device; and
a second information processing device that communicates with the first information processing device,
wherein the first information processing device includes:
an acquiring circuitry to acquire attribute information regarding a first user, acquire information indicating a user having attribute information similar to the attribute information regarding the first user, and acquire appliance condition information as information regarding condition of an appliance used by the user; and
a first generating circuitry to generate a first learning model, which identifies behavior of the first user, based on the appliance condition information.

10. The communication system according to claim 9, wherein
the first information processing device further includes a second generating circuitry,
the acquiring circuitry acquires second acquisition information as at least one item of information out of user appliance condition information as information regarding condition of an appliance used by the first user and user sensor information as information obtained by detecting the first user by a sensor,
the second generating circuitry generates a second learning model, which identifies the behavior of the first user, by using the second acquisition information and the first learning model, and
the second information processing device includes:
a behavior identifying circuitry to identify the behavior of the first user based on the first learning model or the second learning model and at least one item of information out of the information regarding the condition of the appliance used by the first user and the information obtained by detecting the first user by the sensor; and
a service executing circuitry to execute a service based on the behavior of the first user.

11. A generation method performed by an information processing device, the generation method comprising:
acquiring attribute information regarding a first user;
acquiring information indicating a user having attribute information similar to the attribute information regarding the first user;
acquiring appliance condition information as information regarding condition of an appliance used by the user; and
generating a first learning model, which identifies behavior of the first user, based on the appliance condition information.

12. An information processing device comprising:
a processor to execute a program; and
a memory to store the program which, when executed by the processor, performs processes of,
acquiring attribute information regarding a first user;
acquiring information indicating a user having attribute information similar to the attribute information regarding the first user;
acquiring appliance condition information as information regarding condition of an appliance used by the user; and
generating a first learning model, which identifies behavior of the first user, based on the appliance condition information.

13. The information processing device according to claim 1, wherein
the acquiring circuitry acquires first acquisition information as the appliance condition information and sensor information as information obtained by detecting the user by a sensor, and
the first generating circuitry that generates the first learning model based on the first acquisition information.

14. A generation method performed by an information processing device, the generation method comprising:
acquiring attribute information regarding a first user, acquiring information indicating a plurality of users having attribute information similar to the attribute information regarding the first user, acquiring a plurality of pieces of appliance condition information as information regarding condition of appliances respectively used by the plurality of users and a plurality of pieces of sensor information as information obtained by respectively detecting the plurality of users by respectively a plurality of sensors, and acquiring user appliance condition information as information regarding condition of an appliance used by the first user and user sensor information as information obtained by detecting the first user by a sensor;
calculating information regarding a behavior time of the first user based on the user appliance condition information and the user sensor information, calculating information regarding the behavior time of each of the plurality of users based on the plurality of pieces of appliance condition information and the plurality of pieces of sensor information;
identifying information regarding the behavior time similar to the information regarding the behavior time of the first user out of the information regarding the behavior time of each of the plurality of users; and
generating a first learning model, which identifies behavior of the first user, based on the identified information regarding the behavior time, the plurality of pieces of appliance condition information and the plurality of pieces of sensor information.

15. A generation method performed by an information processing device, the generation method comprising:
acquiring attribute information regarding a plurality of users belonging to a first household, acquiring information indicating a household to which residents having attribute information similar to the attribute information regarding the plurality of users belong, and acquiring first household acquisition information as at least one item of information out of household appliance condition information as information regarding condition of an appliance used in the household and household sensor information as information acquired from a sensor used in the household; and
generating a first behavior identification learning model, which identifies behavior of at least one user among the plurality of users, based on the first household acquisition information.

16. An information processing device comprising:
a processor to execute a program; and
a memory to store the program which, when executed by the processor, performs processes of,
acquiring attribute information regarding a first user, acquiring information indicating a plurality of users having attribute information similar to the attribute information regarding the first user, acquiring a plurality of pieces of appliance condition information as information regarding condition of appliances respectively used by the plurality of users and a plurality of pieces of sensor information as information obtained by respectively detecting the plurality of users by respectively a plurality of sensors, and acquiring user appliance condition information as information regarding condition of an appliance used by the first user and user sensor information as information obtained by detecting the first user by a sensor;
calculating information regarding a behavior time of the first user based on the user appliance condition information and the user sensor information, calculating information regarding the behavior time of each of the plurality of users based on the plurality of pieces of appliance condition information and the plurality of pieces of sensor information;
identifying information regarding the behavior time similar to the information regarding the behavior time of the first user out of the information regarding the behavior time of each of the plurality of users; and
generating a first learning model, which identifies behavior of the first user, based on the identified information regarding the behavior time, the plurality of pieces of appliance condition information and the plurality of pieces of sensor information.

17. An information processing device comprising:
a processor to execute a program; and
a memory to store the program which, when executed by the processor, performs processes of,
acquiring attribute information regarding a plurality of users belonging to a first household, acquiring information indicating a household to which residents having attribute information similar to the attribute information regarding the plurality of users belong, and acquiring first household acquisition information as at least one item of information out of household appliance condition information as information regarding condition of an appliance used in the household and household sensor information as information acquired from a sensor used in the household; and
generating a first behavior identification learning model, which identifies behavior of at least one user among the plurality of users, based on the first household acquisition information.
